(19) United States
(12) Patent Application Publication
(10) Pub. No.: US 2010/0290152 A1
(43) Pub. Date: Nov. 18, 2010

(54) METHOD OF MANUFACTURING MAGNETIC RECORDING MEDIUM, AND MAGNETIC RECORDING AND REPRODUCING APPARATUS

(75) Inventors: Hiroshi Uchida, Ichihara-shi (JP); Masato Fukushima, Chiba-shi (JP); Yuko Sakata, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/863,890

(22) PCT Filed: Jan. 14, 2009
(86) PCT No.: PCT/JP2009/050390

§ 371 Date: Jul. 21, 2010

(30) Foreign Application Priority Data
Jan. 23, 2008 (JP) 2008-012384

(51) Int. Cl. G11B 21/02; B05D 5/00

(52) U.S. Cl. 360/75; 427/130; G9B/21.003

(57) ABSTRACT

There is provided a method of manufacturing a magnetic recording medium where a magnetic layer is formed on a substrate, followed by formation of a magnetic pattern, which is a method producing few defective products with low production cost, the method of manufacturing a magnetic recording medium having magnetic recording patterns which are magnetically separated, including, in the following order: a step of forming a magnetic layer on a substrate which has an opening in the centre; a step of applying a resin film to the magnetic layer; a step of pressing against the substrate a film-type mold on which an uneven pattern has been formed; a step of transferring the uneven pattern of the mold onto the resin film; a step of separating the mold from the substrate; and a step of forming magnetic recording patterns on the magnetic layer using the uneven pattern which has been transferred.

### TECHNICAL FIELD

The present invention relates to a method of manufacturing a magnetic recording medium to be used in a hard disk device or the like, and to a magnetic recording and reproducing apparatus.

Priority is claimed on Japanese Patent Application No. 2008-012384, filed Jan. 23, 2008, the content of which is incorporated herein by reference.

### BACKGROUND ART

In recent years, the application range of magnetic recording apparatuses, such as magnetic disk apparatuses, flexible disk apparatuses and magnetic tape apparatuses, has increased considerably, and the importance thereof has also increased. At the same time, an attempt is being made to highly increase the recording density of magnetic recording media used for these apparatuses. In particular, since the introduction of a magnetoresistive (MR) head and a partial response maximum likelihood (PRML) technology, increase in the surface recording density has accelerated even more, and with the introduction of a giant magnetoresistive (GMR) head, a tunnel magnetoresistive (TMR) head or the like in recent years, the recording density has continued to increase at a rate as high as about 100% per year. Regarding these magnetic recording media, there is a demand for a further increase in the recording density in the future. It is therefore required to achieve a higher coercive force, a higher signal-to-noise ratio (SNR) and a higher resolution for a magnetic layer. In addition, in recent years, attempts to increase the surface recording density have also been constantly made by increasing the track density together with the improvements in the linear recording density.

The most recent magnetic recording devices have a track density of as high as 110 kTPI. However, as the track density increases, magnetically recorded information on adjacent tracks interferes with each other, and as a result, the magnetic transition regions at their boundary regions become a noise source, which may easily impair the SNR. The impairment of the SNR may directly lead to a decrease in the bit error rate, which is a drawback to improving the recording density.

In order to increase the surface recording density, it is necessary to make the size of each recording bit on the magnetic recording medium finer and to secure the greatest possible levels of saturation magnetization and magnetic film thickness for each recording bit. However, as the recording bit becomes finer, the minimum magnetization volume per 1 bit becomes small. As a result, the problem of loss of recorded data due to the magnetization reversal by heat fluctuation will occur.

In addition, since the distance between the adjacent tracks will be reduced, a track servo technique with extremely high precision is required in the magnetic recording apparatus, and at the same time, recording is conducted widely whereas reproduction is performed more narrowly than during recording in order to eliminate as much influence as possible from the adjacent tracks in a commonly adopted method. According to this method, inter-track influence can be suppressed to the minimum. On the other hand, it is difficult to obtain satisfactory reproduction output with this method, and thus an adequate level of SNR is difficult to secure.

As one of the methods for solving such a problem of heat fluctuation, of securing the SNR, or of securing the sufficient output, an attempt to increase the track density has been made by forming an uneven pattern along the tracks on the surface of a recording medium or by forming non-magnetic portions between the adjacent tracks, so as to physically separate the recording tracks from one another. Hereafter, such a technique will be referred to as a discrete track method.

As an example of such a discrete track type magnetic recording medium, there is known a magnetic recording medium which is formed on a non-magnetic substrate having an uneven pattern formed on its surface and physically separated magnetic recording tracks and a servo signal pattern are formed on the medium (for example, refer to Patent Document 1). This magnetic recording medium is one in which a ferromagnetic layer is formed, thereof via a soft magnetic layer, on the surface of a substrate which has a plurality of uneven patterns on the surface, and a protective film is formed on the surface of the ferromagnetic layer. In this magnetic recording medium, a magnetic recording region which is magnetically isolated from the surroundings thereof is formed in a projecting region.

According to this magnetic recording medium, since the generation of a magnetic wall in the soft magnetic layer can be suppressed, the influence of the heat fluctuation hardly occurs, and there is no interference between adjacent signals. Therefore, it is considered that a high density magnetic recording medium with less noise can be formed.

The discrete track method includes the following two methods. That is, a method of forming tracks after a magnetic recording medium composed of several layers of thin films is formed, and a method of forming thin films of a magnetic recording medium after an uneven pattern is formed directly on the surface of a substrate in advance or on a thin film layer for the formation of tracks (for example, refer to Patent Documents 2 and 3). Of these, the latter method is often referred to as a pre-embossing method or a substrate processing method. The pre-embossing method has the advantage in that the physical processing with respect to the medium surface is being completed before the medium is formed, and thus the production process can be simplified and also the medium is unlikely to become contaminated during the production process. However, the uneven shape formed on the substrate will be passed onto the films formed thereon. Therefore, there has been a problem in that the flying position and flying height of a recording/reproducing head that records or reproduces data while flying over the medium cannot be stabilized.

On the other hand, for semiconductor devices, high speed action of devices in response to even further acceleration in the trend for the device miniaturization as well as the action of devices with lower power consumption have been required, and highly sophisticated techniques such as functional integration known as “system large-scale integration (LSI)” have also been required. Against such a backdrop, apparatuses for lithography techniques which serve as a core technology in the processing of semiconductor devices are becoming more expensive as the miniaturization of devices progresses.

Currently, a shift from the KrF laser lithography in which the minimum line width is 130 nm to the ArF laser lithography has been started in the photoexposure lithography technique.

The minimum line width for the ArF laser lithography adopted in the manufacturing level is 100 nm, whereas the manufacturing of devices having a minimum line width of 90 nm has started in the year 2003, and those having a minimum line width of 65 nm and 45 nm have started their manufacturing in the year 2005 and 2007, respectively.

In such circumstances, F₂ laser (F₂ excimer laser) lithography, extreme ultraviolet lithography (EUVL), electron beam projection lithography (EPL) and X-ray lithography have been eagerly anticipated to serve as the techniques to achieve even finer processing. These lithography techniques have already been successful in preparing patterns from 40 nm to 70 nm in size.

However, as the miniaturization of devices progresses, in addition to the exponential increase in the initial cost of exposure apparatuses themselves, cost of the mask for achieving a resolution equivalent to the wavelength of used light source is also increasing rapidly, and thus the nanoimprinting lithography has been attracting attention as a processing technique for achieving a resolution of about 10 nm while being a low cost process (refer to Patent Document 4).

In Patent Document 5, transfer of uneven patterns on the surface of a magnetic disc by the use of a nanoimprinting process and also the position alignment of dies for the nanoimprinting process using an opening of the disc have been disclosed.

Patent Document 6 has disclosed the use of a resin stamper as a nanoimprinting stamper for a magnetic recording medium which has been transferred from the master disc.

[Patent Document 1] Japanese Unexamined Patent Application, First Publication No. 2004-164692

[Patent Document 2] Japanese Unexamined Patent Application, First Publication No. 2004-178793

[Patent Document 3] Japanese Unexamined Patent Application, First Publication No. 2004-178794

[Patent Document 4] Published Japanese Translation No. 2004-504718 of PCT International Publication

[Patent Document 5] Japanese Unexamined Patent Application, First Publication No. 2004-103232

[Patent Document 6] Japanese Unexamined Patent Application, First Publication No. 2005-038477

### DISCLOSURE OF INVENTION

### Problems to be Solved by the Invention

As described above, in the process for producing so-called discrete track media or patterned media having magnetic recording patterns which are magnetically separated, nanoimprinting techniques have been employed. As a resin used in the pattern transfer in this production process, it is preferable to use a photocurable resin since it is simple and easy to use. However, metallic stampers have been used for the nanoimprinting process in many cases, and since metallic stampers do not transmit light, a photocurable resin cannot be used in the pattern transfer, which is a problem. In addition, the pattern transfer using a stamper may result in the production of a large quantity of defective products when the stamper is broken. Furthermore, since metallic stampers are expensive, the use thereof has increased the production cost of magnetic recording media.

Additionally, the use of a resin as a stamper in the pattern transfer which is capable of transmitting light has also been disclosed. However, even when a resin is used as a stamper, in those cases where the stamper is broken, a large quantity of defective products will be produced anyway.

An object of the present invention is to solve these problems by providing a method for manufacturing a magnetic recording medium which produces few defective products with a low production cost.

### Means for Solving the Problems

In order to achieve the above-mentioned object, the present invention has adopted the aspects described below.

(1) A method of manufacturing a magnetic recording medium having magnetic recording patterns which are magnetically separated, the method characterized by including, in the following order: a step of forming a magnetic layer on a substrate which has an opening in the center; a step of applying a resin film onto the magnetic layer; a step of pressing against the substrate a film-type mold on which an uneven pattern has been formed; a step of transferring the uneven pattern of the mold onto the resin film; a step of separating the mold from the substrate; and a step of forming a magnetic recording pattern on the magnetic layer using the uneven pattern which has been transferred.

(2) The method of manufacturing a magnetic recording medium according to the above aspect (1), characterized in that the film-type mold has an opening, and the mold is pressed against the substrate by making this opening to coincide with the opening of the substrate.

(3) A method of manufacturing a magnetic recording medium characterized in that identical patterns are continuously provided on the film-type mold, thereby conducting in succession the steps described in the above aspect (1) or (2) on a plurality of substrates.

(4) The method of manufacturing a magnetic recording medium according to any one of the above aspects (1) to (3), characterized in that the resin film applied onto the magnetic layer is a radiation-curable resin, and radiation for curing the resin is irradiated from the back surface of the mold when transferring the uneven pattern of the mold onto the resin film.

(5) The method of manufacturing a magnetic recording medium according to any one of the above aspects (1) to (4), characterized in that the step of applying a resin film onto the magnetic layer, the step of pressing against the substrate a film-type mold on which an uneven pattern has been formed and the step of transferring the uneven pattern of the mold onto the resin film are carried out simultaneously on both surfaces of the substrate.

(6) A magnetic recording and reproducing apparatus characterized by including a combination of: a magnetic recording medium manufactured by the method of manufacturing a magnetic recording medium described in any one of the above aspects (1) to (5); a driving unit that drives the magnetic recording medium in the recording direction; a magnetic head constituted of a recording section and a reproducing section; a head driving unit that relatively moves the magnetic head with respect to the magnetic recording medium; and a recording/reproduction signal processing device that inputs signals to the magnetic head and reproduces output signals from the magnetic head.

### Effect of the Invention

According to the present invention, the patterns of magnetic layers in the magnetic recording media such as the so-called patterned media can be efficiently formed. Therefore, it is possible to provide a magnetic recording medium with a high recording density at high productivity.

### BRIEF DESCRIPTION OF THE DRAWINGS

FIG. 1 is a cross sectional view showing an apparatus for manufacturing a resin mold according to the present invention.

FIG. 2 is a cross sectional view showing a state where a mother stamper is pressed against a resin substrate.

FIG. 3 is a diagram showing a bottom surface of a translucent pressing board applied to the apparatus for manufacturing a resin mold.

FIG. 4 is a plan view of a mother stamper portion applied to the apparatus for manufacturing a resin mold.

FIG. 5 is a cross sectional view of a resin substrate which is punched by the apparatus for manufacturing a resin mold.

FIG. 6 is a cross sectional view showing a state where the resin substrate is punched by the apparatus for manufacturing a resin mold.

FIG. 7 is a cross sectional view showing a state after the resin substrate is being punched by the apparatus for manufacturing a resin mold.

FIG. 8 is a cross sectional view showing a state where the resin mold which has been punched by the apparatus for manufacturing a resin mold is taken out.

FIG. 9 is a cross sectional view showing a state where another resin substrate is set to the apparatus for manufacturing a resin mold.

FIG. 10 is a schematic diagram showing a step of manufacturing a magnetic recording medium of the present invention.

FIG. 11 is a diagram showing a film-type, continuous mold.

FIG. 12 is a schematic diagram showing a magnetic recording and reproducing apparatus of the present invention.

### DESCRIPTION OF THE REFERENCE SYMBOLS

1: First platen
1a: Through hole
1b: Through hole
2: Upper die set
3: Second platen
5: Lower die set
6: Disc-shaped cutter set member
7: Outer peripheral cutter portion
7a: Inner peripheral surface
7b: Cutting blade surface
7c: Outer blade surface
7A: Outer peripheral cutter blade
8: Inner peripheral cutter portion
8A: Inner peripheral cutter blade
8a: Inner peripheral cutter blade
8b: Cutting blade surface
8c: Concave portion
9: Cutter member
10: Radiation source supporting mechanism
11: Irradiation device
12: Supporting member
15: Radiation-transmitting pressing board
16: Inside sliding supporting member
16a: Concave portion
17: Cylindrical outside sliding supporting member
18: Cradle
20: Elastic member
21: Mother stamper
25: Film-type substrate
25B: Outer peripheral portion
25a: Hard layer
25b: Soft resin film
25c: Curable resin film
30: Resin mold
30: Mold
31: Removing rod
59: Substrate
59a: Opening
59b: Outer peripheral portion
59c: Inner peripheral portion
59A: Resin mold
100: Non-magnetic substrate
200: Magnetic layer
300: Mask layer
400: Resin film
500: Mold
600: Milling ions
700: Part in magnetic layer which is partially subjected to ion milling
800: Part in magnetic layer with reformed magnetic properties
900: Protective film
1000: Magnetic recording medium
101: Medium driving unit
102: Magnetic head
103: Head driving unit
104: Recording/reproducing signal system

### BEST MODE FOR CARRYING OUT THE INVENTION

The present invention is a method of manufacturing a magnetic recording medium having magnetic recording patterns which are magnetically separated, the method characterized by including, in the following order: a step of forming a magnetic layer on a substrate which has an opening in the centre; a step of applying a resin film to the magnetic layer; a step of pressing against the substrate a film-type mold on which an uneven pattern has been formed; a step of transferring the uneven pattern of the mold onto the resin film; a step of separating the mold from the substrate; and a step of forming magnetic recording patterns on the magnetic layer using the uneven pattern which has been transferred.

The film-type mold used in the present invention on which an uneven pattern has been formed is a film constituted of a flexible thin plate made of a metal, a resin or the like and having an uneven pattern corresponding to the magnetic recording pattern of the magnetic recording medium formed on the surface thereof. In the present invention, by adopting such a configuration for the mold used for the pattern transfer, the steps of supplying the mold to the surface of the substrate for a magnetic recording medium, pressing of the mold thereto, transferring of patterns, and detaching and recovering of the mold therefrom can be easily carried out, and thus the manufacturing of magnetic recording media can be conducted with higher productivity. That is, a die made of a nickel alloy or a resin has conventionally been used for transferring the magnetic recording patterns to the surface of a substrate for a magnetic recording medium. However, these dies exhibit low flexibility which makes their smooth supply difficult, and simultaneous or continuous supply of numerous molds are also difficult, which has resulted in the production of magnetic recording media with low productivity.

In addition, since a film-type mold is used for transferring the magnetic recording patterns in the present invention, it becomes possible to readily form an opening or the like in the mold. Therefore, by using the opening, it becomes possible to readily position the substrate for a magnetic recording medium and the mold, and thus a method for manufacturing a magnetic recording medium with high productivity can be provided. That is, a rotating-type magnetic recording medium used in a hard disk or the like has an opening at the center thereof so as to attach the medium to a spindle of a rotating motor. However, the magnetic recording patterns formed in discrete track media or patterned media need to be formed with high precision with respect to the opening at the center, and when a magnetic recording pattern of a magnetic recording medium is provided eccentrically with respect to the opening at the center, a head that reads information from or writes information to a magnetic recording medium cannot follow the magnetic recording patterns, and thus reading information from the magnetic recording medium or writing information thereto may be inhibited. Therefore, with conventional manufacturing methods, the process for positioning the substrate for a magnetic recording medium and the mold for pattern transfer required a long time. On the other hand, since a film is used in the present invention in which a mold for pattern transfer can be readily processed, it becomes possible to readily provide a positioning hole such as an opening to the film, and the positioning process using the opening can readily be conducted.

In the present invention, the opening of a film-type mold can easily be made to coincide with the opening of a substrate for a magnetic recording medium within a short space of time, and the mold can also be pressed easily against the substrate with high precision, which makes it possible to considerably enhance the productivity in the manufacturing of magnetic recording media.

In addition, since a film-type mold is used in the present invention, this film can readily be made long, making it possible to continuously provide identical transfer patterns onto the film. In other words, to a plurality of substrates, the steps of supplying the mold to the surface of the substrate for a magnetic recording medium, pressing of the mold thereto, transferring of patterns, and detaching and recovering of the mold therefrom can be carried out in succession, or alternatively, different steps can be conducted simultaneously, which makes it possible to considerably enhance the productivity in the manufacturing of magnetic recording media. Further, a mold formed on the film is used once only and is not reused. As a result, the occurrence of a large quantity of defective magnetic recording media due to the damage caused to the mold can be avoided, and a high precision mold with little pattern deterioration can be provided at any time. Furthermore, even when a mold formed on a film is reused after being used for transferring patterns, cleaning of the mold after use and making decision as to whether the mold can be reused or not can be performed in succession without stopping the manufacturing apparatus.

In the present invention, a resin film applied onto the magnetic film can be a radiation-curable resin. In other words, since the mold used in the present invention can be made into a thin plate, radiation for curing the resin can be irradiated from the back surface of the mold when transferring the uneven pattern of the mold onto the resin film. As a result, a mask layer for forming a magnetic recording pattern on the magnetic film surface can be formed in a short space of time, which makes it possible to enhance the productivity in the manufacturing of magnetic recording media.

In addition, in the present invention, the step of applying a resin film onto the magnetic layer, the step of pressing against the substrate a film-type mold on which an uneven pattern has been formed and the step of transferring the uneven pattern of the mold onto the resin film can be carried out simultaneously on both surfaces of the substrate. That is, the mold used in the present invention is a film-type mold with high flexibility and is therefore easy to handle, and the film can also be made long. Accordingly, the steps of supplying the mold to both surfaces of the substrate for a magnetic recording medium, pressing of the mold thereto, transferring of patterns, and detaching and recovering of the mold therefrom can be easily carried out.

Next, preferred embodiments for carrying out the present invention will be described below in detail using a series of diagrams. However, it should be noted that the present invention is in no way limited to the embodiments described below.

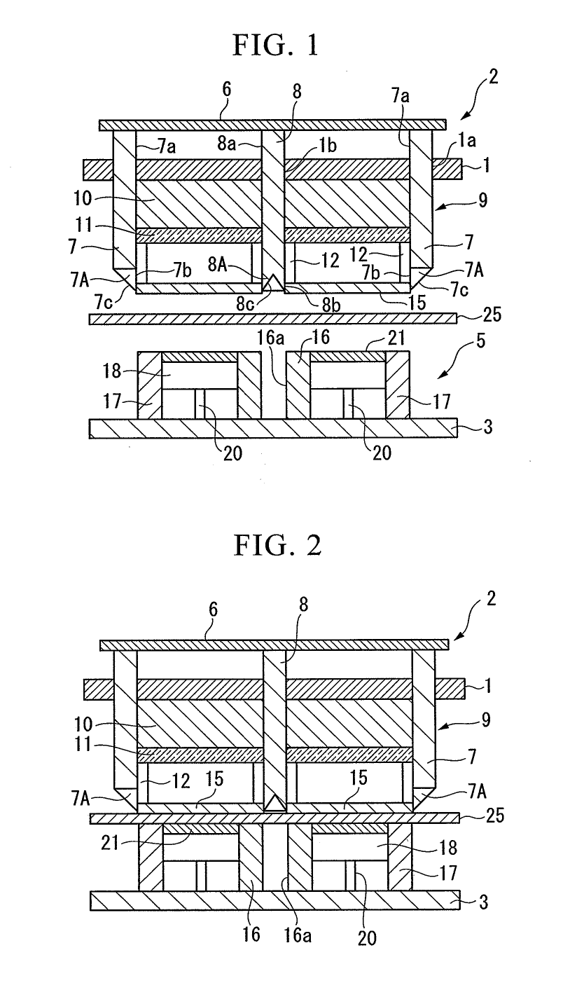

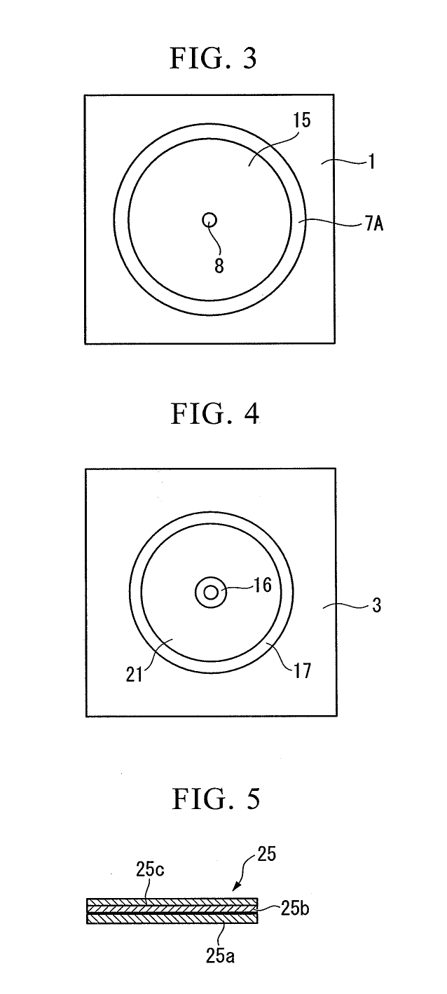

FIGS. 1 to 9 show an apparatus for manufacturing a film-type mold used in the present invention. As shown in FIG. 1, a manufacturing apparatus with such configurations is constituted by having an upper die set 2 supported by a first platen 1 and a lower die set 5 supported by a second platen 3. Here, the first platen 1 is supported by an actuator device for the vertical movement such as an oil hydraulic cylinder (not shown) and is provided so as to be freely movable vertically, and the second platen 3 is mounted on a base (not shown) and fixed thereon.

A disc-shaped cutter set member 6 is provided above the first platen 1 in a freely movable manner vertically by being supported by an actuator device for the vertical movement such as an oil hydraulic cylinder (not shown). A cylindrical outer peripheral cutter portion 7 is provided on the outer peripheral portion side of the bottom surface of the cutter set member 6. A bar shaped inner peripheral cutter portion 8 is provided at the center of the bottom surface of the cutter set member 6. A cutter member 9 is constituted of these outer peripheral cutter portion 7 and inner peripheral cutter portion 8. In addition, a ring shaped outer peripheral cutter blade 7A is formed downwardly on the top end side of the outer peripheral cutter portion 7, and an inner peripheral cutter blade 8A is formed on the top end side of the inner peripheral cutter portion 8.

The outer peripheral cutter portion 7 penetrates through and is extended below the first platen 1 via a through hole la formed in the outer peripheral portion of the platen 1, and the inner peripheral cutter portion 8 penetrates through and is extended below the first platen 1 via a through hole 1b formed at the center of the platen 1. It is configured such that the outer peripheral cutter portion 7 and the inner peripheral cutter portion 8 are moved vertically in response to the vertical movement of the cutter set member 6 with respect to the first platen 1. The cross section of the outer peripheral cutter blade 7A is formed into a triangular shape, and has a cutting blade surface 7b extended directly from an inner peripheral surface 7a of a cylindrical outer peripheral cutter portion 7 and an outer blade surface 7c inclined towards the outside of the outer peripheral cutter portion 7. The inner peripheral cutter blade 8A is configured into a cutting blade shape constituted of a cutting blade surface 8b which is extended directly from an outer peripheral surface of a bar shaped inner peripheral cutter portion 8 and a mortar-shaped concave portion 8c having a cross section of an inverted V shape which is formed at the top end portion of the inner peripheral cutter portion 8.

A radiation source supporting mechanism 10 and an irradiation device 11 are provided in a part below the platen 1 and in between the outer peripheral cutter portion 7 and the inner peripheral cutter portion 8. Accordingly, it is configured so that ultraviolet light can be irradiated downwards from a radiation source which is installed internally in the irradiation device 11, such as a high pressure mercury lamp, a low pressure mercury lamp, a metal halide lamp, a xenon lamp, a xenon mercury lamp and an ultraviolet LED lamp. Among these radiation sources, it is particularly desirable to use an ultraviolet LED lamp because the level of heat generation which may cause distortions in the molded products is low. In terms of the wavelength for ultraviolet rays used in such cases, a wavelength within the range from 220 nm to 400 nm can be mentioned.

A frame shaped supporting member 12 is provided below the irradiation device 11, and a radiation-transmitting pressing board 15 made of a disc-shaped glass board or the like is provided below the supporting member 12. The radiation source supporting member 10, the irradiation device 11, the supporting member 12 and the radiation-transmitting pressing board 15 are integrated with the platen 1. Accordingly, it is configured so that the radiation-transmitting pressing board 15 moves vertically in response to the vertical movement of the first platen 1.

On the other hand, a cylindrical, inside sliding supporting member 16 and a cylindrical, outside sliding supporting member 17 having the same height are provided on the second platen 3. A disc-shaped cradle 18 is fitted between these members so as to be freely slidable vertically, and the cradle 18 is supported by an elastic member 20 made of a spring member or the like which is provided therebelow. A doughnut-shaped mother stamper 21 is provided on the cradle 18 so as to protrude upward to some extent, as compared to the sliding supporting members 16 and 17.

The mother stamper 21 has a pattern to be transferred, formed on the upper surface side thereof. In the embodiment of the present invention, since a resin mold for forming an uneven pattern on the surface of a discrete track type magnetic recording medium is manufactured, an uneven pattern for a thin film to be formed on the surface of a discrete track type magnetic recording medium has been formed on the surface of the mother stamper 21.

In addition, a concave portion 16a capable of inserting the aforementioned rod-shaped inner peripheral cutter blade 8A is formed at the center of the inside sliding supporting member 16.

For manufacturing a resin mold by the manufacturing apparatus having a configuration shown in FIG. 1, a film-type substrate is prepared to be used as a base for an intended film-type mold.

As an example of such substrates, film-type substrate 25 having a three layer structure as shown in FIG. 5 can be used. In the present embodiment, the substrate 25 is constituted of a film-type hard layer 25a, a soft resin film 25b and a curable resin film 25c.

It is preferable to use, for the hard layer 25a, a material having high ultraviolet transmittance and which is hardly deformable during punching. Accordingly, the hard layer 25a is composed of resin materials such as aromatic polyesters such as polyethylene terephthalate and polyethylene naphthalate; cycloolefin polymers such as Zeonor (product name, manufactured by Zeon Corporation), TOPAS (product name, manufactured by Polyplastics Co., Ltd.) and ARTON (product name, manufactured by JSR Corporation); hard thermosetting resins such as aromatic polycarbonates and alicyclic polyimides; polyolefin-based thermosetting resins such as polypropylene, poly(4-methylpentene), polystyrene and PMMA; or thermosetting resin films such as epoxy resins and allyl resins. In addition, the thickness of the hard layer 25a can be made within the range from about 10 to about 3,000 μm.

It is preferable to use, for the soft resin film 25b, a material having high ultraviolet transmittance and which exhibits, during the imprinting using a film-type mold of the present invention, both the function to reinforce adhesion with the hard layer 25a and the curable resin film 25c and the flexibility to follow the swelling of the substrate which is subjected to the imprinting. Accordingly, the soft resin film 25b is composed of resin materials such as “silicone rubber, urethane rubber and polypropylene films”. In addition, the thickness of the soft adhesion layer 25b can be made within the range from about 0.5 to about 1,000 μm. Note that in those cases where the extent of swelling of the hard layer 25a is small in the film-type substrate 25 having a three layer structure, it is possible to form a substrate having a two layer structure constituted of the hard layer 25a and the curable resin film 25c by omitting the soft resin film 25b. In addition, in those cases where a two layer structure is adopted, in order to strengthen the adhesion between the hard layer 25a and the curable resin film 25c, it is also possible to subject one surface of the hard layer 25a to a surface treatment, such as a corona treatment, for enhancing adhesiveness.

Further, for the hard layer 25a and the soft resin film 25b, those which are integrally formed and commercially available such as a PET film of an easy-adhesion grade (Cosmoshine A-4100 (product name) manufactured by Toyobo Co., Ltd.) or Teijin Tetron film O3 (manufactured by Teijin DuPont Films Japan Limited) can also be used, and they can also be used directly as they are for the purpose.

The curable resin film 25c is composed of at least one resin having a curable group such as a (meth)acryloyl group, an allyl group, a vinyl group, an oxetanyl group, a glycidyl group, a cyclohexene oxide group and a vinyl ether group. It is particularly desirable that the curable resin film 25c be composed of a resin having a curable group which can be cured rapidly such as a (meth)acryloyl group, an oxetanyl group, a cyclohexene oxide group and a vinyl ether group.

Examples of the resins usable herein which has a (meth)acryloyl group include mono(meth)acrylates such as methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, hexyl (meth)acrylate, octyl (meth)acrylate, 2-ethylhexyl (meth)acrylate, decyl (meth)acrylate, isobornyl (meth)acrylate, cyclohexyl (meth)acrylate, phenyl (meth)acrylate, benzyl (meth)acrylate, 2-hydroxyethyl (meth)acrylate, 2-hydroxypropyl (meth)acrylate, 3-hydroxypropyl (meth)acrylate, 2-hydroxybutyl (meth)acrylate and 2-hydroxyphenylethyl (meth)acrylate; (meth)acrylamides such as N,N-dimethyl (meth)acrylamide, N,N-diethyl (meth)acrylamide and N-acryloyl morpholine; polyfunctional (meth)acrylates such as ethylene glycol di(meth)acrylate, propylene glycol di(meth)acrylate, 1,4-butanediol di(meth)acrylate, diethylene glycol di(meth)acrylate, triethylene glycol di(meth)acrylate, trimethylolpropane di(meth)acrylate, trimethylolpropane tri(meth)acrylate and pentaerythritol penta(meth)acrylate; and so-called epoxy (meth)acrylates formed by adding (meth)acrylic acid to epoxy resins such as bisphenol A epoxy resins, hydrogenated bisphenol A epoxy resins, brominated bisphenol A epoxy resins, bisphenol F epoxy resins, novolac epoxy resins, phenol novolac epoxy resins, cresol novolac epoxy resins, alicyclic epoxy resins, N-glycidyl epoxy resins, novolac epoxy resins of bisphenol A, chelate epoxy resins, glyoxal epoxy resins, amino-group containing epoxy resins, rubber modified epoxy resins, dicyclopentadiene phenolic epoxy resins, silicone modified epoxy resins and ε-caprolactone modified epoxy resins.

Examples of the resins which has an allyl group include allyl ethers such as ethylene glycol monoallyl ether and allyl glycidyl ether; monoallyl esters such as allyl acetate and allyl benzoate; diallyl esters such as diallyl amine, 1,4-cyclohexane diallyl dicarboxylate, diallyl phthalate, diallyl terephthalate and diallyl isophthalate; and allyl ester resins obtained by reacting allyl alcohols with oligo esters such as oligopropylene terephthalate.

Examples of the resins which has a vinyl group include monovinyl ethers such as n-propylvinyl ether, isopropylvinyl ether, n-butylvinyl ether, isobutylvinyl ether, 2-ethylhexylvinyl ether, octadecylvinyl ether and cyclohexylvinyl ether; monovinyl esters such as vinyl acetate, vinyl propionate, vinyl butyrate and vinyl benzoate; divinyl esters such as divinyl adipate; N-vinyl amides such as N-vinylpyrrolidone, N-methyl-N-vinylacetamide and N-vinylformamide; styrene derivatives such as styrene, 2,4-dimethyl-α-methylstyrene, o-methylstyrene, m-methylstyrene, p-methylstyrene, 2,4-dimethylstyrene, 2,5-dimethylstyrene, 2,6-dimethylstyrene, 3,4-dimethylstyrene, 3,5-dimethylstyrene, 2,4,6-trimethylstyrene, 2,4,5-trimethylstyrene, pentamethylstyrene, o-ethylstyrene, m-ethylstyrene, p-ethylstyrene, o-chlorostyrene, m-chlorostyrene, p-chlorostyrene, o-bromostyrene, m-bromostyrene, p-bromostyrene, o-methoxystyrene, m-methoxystyrene, p-methoxystyrene, o-hydroxystyrene, m-hydroxystyrene, p-hydroxystyrene, 2-vinylbiphenyl, 3-vinylbiphenyl, 4-vinylbiphenyl, 1-vinylnaphthalene, 2-vinylnaphthalene, 4-vinyl-p-terphenyl, 1-vinylanthracene, α-methylstyrene, o-isopropenyl toluene, m-isopropenyl toluene, p-isopropenyl toluene, 2,4-dimethyl-α-methylstyrene, 2,3-dimethyl-α-methylstyrene, 3,5-dimethyl-α-methylstyrene, p-isopropyl-α-methylstyrene, α-ethylstyrene and α-chlorostyrene; divinyl ethers such as ethylene glycol divinyl ether, 1,4-butanediol divinyl ether, 1,6-hexanediol divinyl ether, 1,9-nonanediol divinyl ether, cyclohexanedimethanol divinyl ether, diethylene glycol divinyl ether and triethylene glycol divinyl ether; polyfunctional vinyl ethers such as trimethylolpropane trivinyl ether and pentaerythritol tetravinyl ether; and divinyl aryls such as divinyl benzene

Examples of the resins which has an oxetanyl group include monooxetanyl compounds such as 3-ethyl-3-hydroxymethyl oxetane and 3-ethyl-3-methacryloxymethyl oxetane; and other polyfunctional oxetane resins such as Aron Oxetane OXT-121 (product name) and OX-SQ (product name) manufactured by Toagosei Co., Ltd., and OXTP (product name) and OXBP (product name) manufactured by Nippon Steel Chemical Co., Ltd.

Examples of the resins which has a glycidyl group include bisphenol A epoxy resin, hydrogenated bisphenol A epoxy resin, brominated bisphenol A epoxy resin, bisphenol F epoxy resin, novolac epoxy resin, phenol novolac epoxy resin, cresol novolac epoxy resin, N-glycidyl epoxy resin, novolac epoxy resin of bisphenol A, chelate epoxy resin, glyoxal epoxy resin, amino-group containing epoxy resin, rubber modified epoxy resin, dicyclopentadiene phenolic epoxy resin, silicone modified epoxy resin and ε-caprolactone modified epoxy resin.

Examples of the resins which has a cyclohexene oxide group include Celloxide 2021P (product name), Celloxide 3000 (product name), EHPE 3150 (product name) and EHPE 3150CE (product name) manufactured by Daicel Chemical Industries, Ltd.

In addition, the thickness of the radiation-curable resin film 25c can be made within the range from about 0.05 to about 50 μm, so that at least 30% of ultraviolet rays having a wavelength of 400 nm or less are preferably transmitted.

The film-type substrate 25 having the aforementioned configuration is placed between the mother stamper 21 and the radiation-transmitting pressing board 15 while making the radiation-curable resin film 25c therein to face downward as shown in FIG. 1, and the substrate 25 is then pressed against the surface of the mother stamper 21 at a specified pressure via the radiation-transmitting pressing board 15 by lowering the first platen 1. For the mother stamper 21, a metal plate composed of materials, such as a Ni alloy, which can be subjected to high-precision processing and enable the precise formation of fine and uneven patterns with currently available molding techniques can be applied. A fine and uneven pattern which is a reverse pattern of the fine and uneven pattern formed on the surface of the mother stamper 21 can be transferred onto the radiation-curable resin film 25c of the substrate 25 by this operation (the process described so far will be referred to as a transfer step (1)).

Further, while pressing the substrate 25 onto the surface of the mother stamper 21, ultraviolet radiation is irradiated from the irradiation device 11, thereby curing the radiation-curable resin film 25c (the process described so far will be referred to as a curing step (2)).

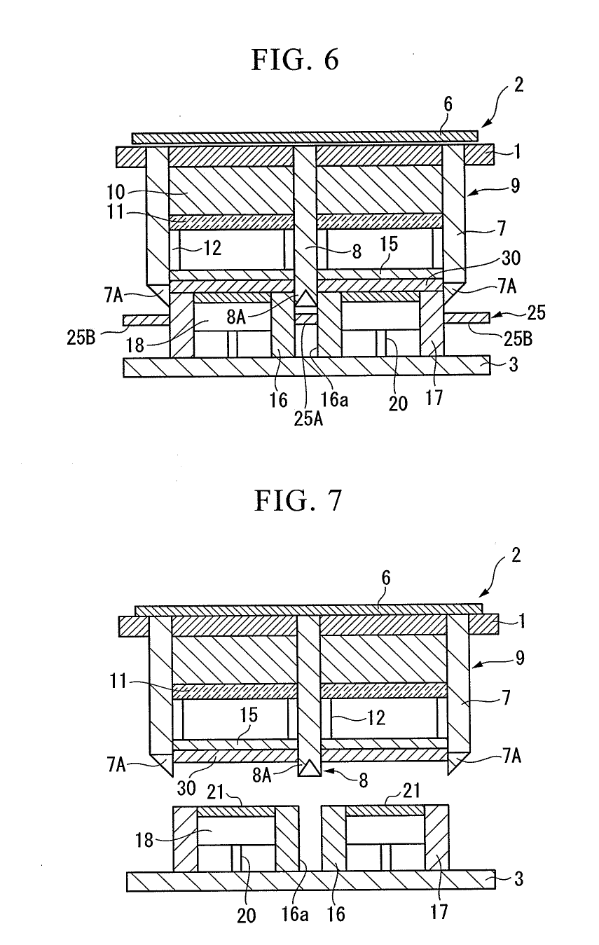

Before, after, or even during the above curing step, a disc-shaped resin mold 30 is punched from the substrate 25 using the outer peripheral cutter blade 7A and the inner peripheral cutter blade 8A by lowering the outer peripheral cutter portion 7 and the inner peripheral cutter portion 8 due to the lowering of the cutter set member 6 as shown in FIG. 6 (the process described so far will be referred to as a punching step (3)).

During this punching step, because the outer peripheral cutter blade 7 punches the substrate 25 while sliding along the surface extending from the outer periphery of a cylindrical, outside sliding supporting member 17 whereas the inner peripheral cutter blade 8 punches the substrate 25 while sliding along the inside of the inside sliding supporting member 16, the substrate 25 can be punched at an accurate position, thereby obtaining a doughnut-shaped mold 30 having an inner diameter and outer diameter with intended sizes. In addition, in the process for removing the mold 30 by punching the substrate 25 as shown in FIG. 6, the central portion 25A of the substrate 25 punched by the inner peripheral cutter blade 8A is discharged to the side where a concave portion 16a is present at the center of the sliding supporting member 16, and an outer peripheral portion 25B of the substrate 25 punched by the outer peripheral cutter blade 7A is discharged to the outer peripheral side of the sliding supporting member 17. Here, because the inner diameter of the concave portion 16a of the sliding supporting member 16 is made almost as large as the outer diameter of the inner peripheral cutter blade 8A, when punching the substrate 25, the substrate 25 can be punched at an accurate position without difficulty by the inner peripheral cutter blade 8A along the inner peripheral edge of the concave portion 16a, and thus the punching accuracy can be enhanced. In addition, because the outer diameter of the sliding supporting member 17 is made almost as large as the inner diameter of the outer peripheral cutter blade 7A, when punching the substrate 25, the substrate 25 can be punched at an accurate position without difficulty by the outer peripheral cutter blade 7A along the outer peripheral edge of the sliding supporting member 17, and thus the punching accuracy can be enhanced. Therefore, the substrate 25 having an intended doughnut shape can be punched with high accuracies in both the shape and position of the inner circle as well as the shape and position of the outer circle.

In the present invention, when a film-type mold is made into a long shape in which identical patterns are provided in succession, the punching by a cutter blade is carried out only to the inner circle and the punching to the outer circle will be omitted.

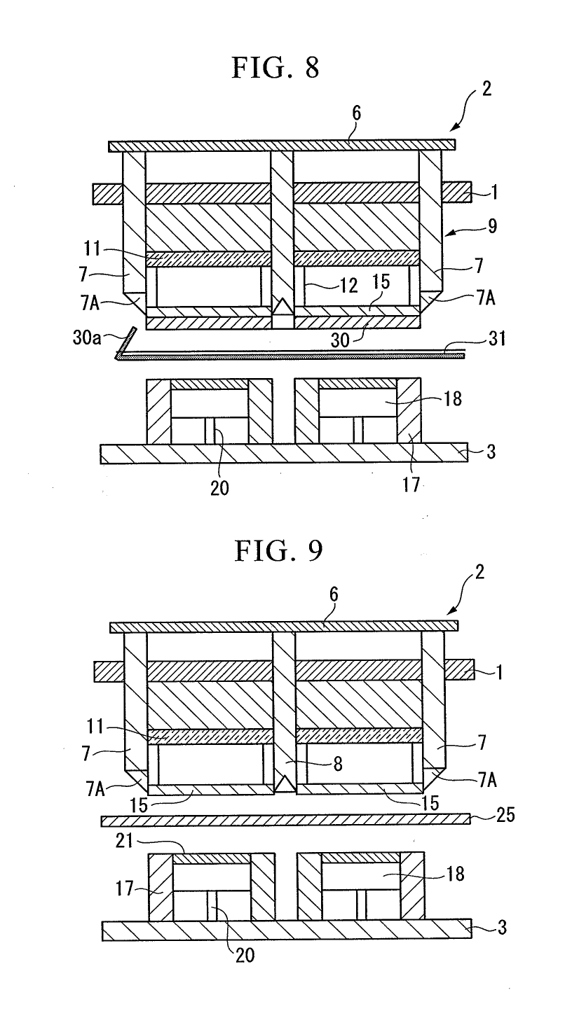

After punching the substrate 25 as shown in FIG. 6, if the first platen 1 and the cutter set member 6 are raised as shown in FIG. 7, the mold 30 is elevated while being sandwiched between the outer peripheral cutter blade 7A and the inner peripheral cutter blade 8A. Accordingly, as shown in FIG. 8, the outer peripheral cutter blade 7A and the inner peripheral cutter blade 8A are moved so as to detach from the mold 30 by raising the cutter set member 6 with respect to the first platen 1, and the mold 30 can then be taken out using a separating device such as a removing rod 31 having a bending portion 31 a at the top end thereof. During this removal process, since the outer peripheral cutter blade 7A and the inner peripheral cutter blade 8A are already detached from the mold 30 and the mold 30 is thus in close contact only with the radiation-transmitting pressing board 15, the mold 30 can be readily separated using the removing rod 31.

Once the mold 30 is detached from the radiation-transmitting pressing board 15, another piece of substrate 25 is set between the radiation-transmitting pressing board 15 and the mother stamper 21 as shown in FIG. 9. The mold 30 can then be obtained as described earlier by carrying out the pressing step, the ultraviolet ray irradiation step and the punching step all over again in an order as described previously based on FIGS. 2 to 8, and the mold 30 can be mass produced by repeatedly carrying out the operations described above.

The mold 30 manufactured in the above-mentioned manner is used for manufacturing the discrete track type magnetic recording media or patterned media. As an example of this kind of magnetic recording medium, those in which a magnetic layer or protective layer has been formed on the surface of a non-magnetic substrate can be mentioned.

For example, a magnetic layer as described above which is formed on the surface of a non-magnetic substrate may be either an in-plane magnetic layer or a perpendicular magnetic layer. These magnetic layers are preferably formed using an alloy having Co as a major component thereof.

For example, as a magnetic layer for an in-plane magnetic recording medium, a laminated structure composed of a non-magnetic CrMo underlayer and a ferromagnetic CoCrPtTa magnetic layer can be used.

As a magnetic layer for a perpendicular magnetic recording medium, for example, a laminated structure constituted of a backing layer composed of a soft magnetic FeCo alloy (e.g., FeCoB, FeCoSiB, FeCoZr, FeCoZrB and FeCoZrBCu), an FeTa alloy (e.g., FeTaN and FeTaC) and a Co alloy (e.g., CoTaZr, CoZrNB and CoB), an orientation controlling film composed of Pt, Pd, NiCr, NiFeCr or the like, an intermediate film made of Ru or the like, which will be provided as necessary, and a magnetic layer composed of a 60Co-15Cr-15Pt alloy or a 70Co-5Cr-15Pt-10SiO₂ alloy can be used.

The thickness of the magnetic layer is not less than 3 nm and not more than 20 nm and preferably not less than 5 nm and not more than 15 nm. The magnetic layer may be formed in accordance with the type and the laminated structure of the magnetic alloy used so that sufficient head output/input can be obtained. The thickness of the magnetic layer needs to be equal to or more than a certain thickness in order to obtain predetermined output greater than certain output at the time of reproduction. On the other hand, since various parameters representing the recording and reproducing characteristics are usually impaired as the level of output increases, it is necessary to determine the optimum thickness. The magnetic layer is usually formed as a thin film by a sputtering process.

In the present invention, although a magnetic recording pattern which is magnetically separated is formed on the magnetic layer, prior to this process, a mask layer that corresponds with the magnetically recording pattern is formed on the surface of the magnetic layer. Formation of the mask layer includes a step of applying a resin film onto the magnetic layer, a step of pressing against the substrate a film-type mold on which an uneven pattern has been formed, a step of transferring the uneven pattern of the mold onto the resin film and a step of separating the mold from the substrate. Each of the steps will be described below in detail. It should be noted that the manufacturing method of the present invention is in no way limited to the steps described below.

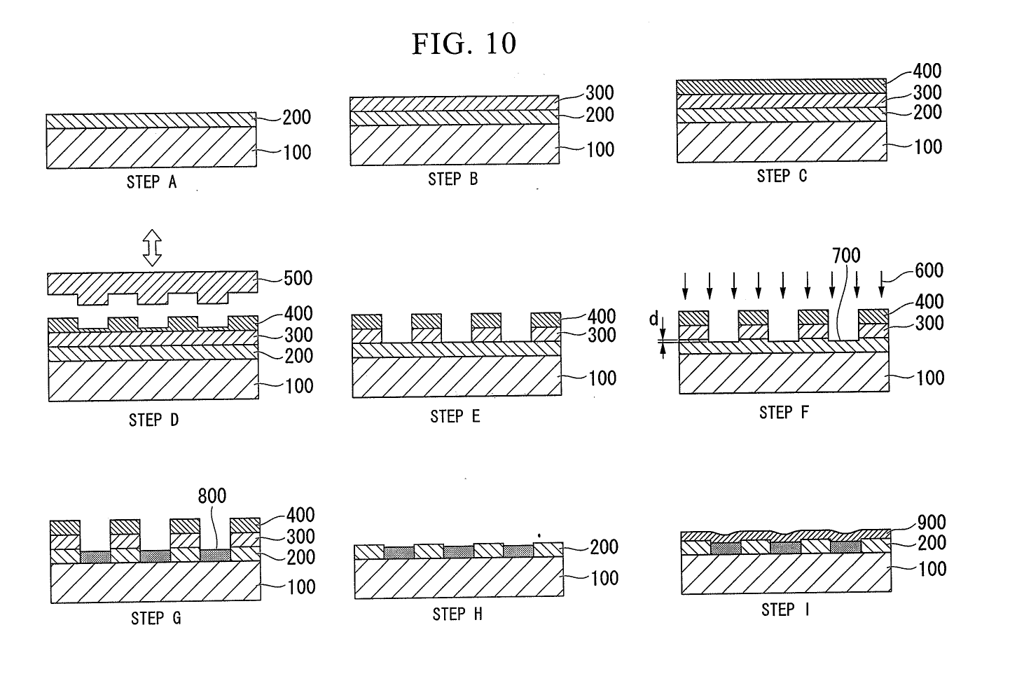

The magnetic recording medium of the present invention can be manufactured, for example, for example, by a method including the following steps in the following order as shown in FIG. 10: the step A of forming at least a magnetic layer 200 on a non-magnetic substrate 100, the step B of forming a mask layer 300 on top of the magnetic layer 200, the step C of applying a resin film 400 on top of the mask layer 300, the step D of transferring a negative pattern of the magnetic recording pattern to the resin film 400 using a film-type mold 500 (the arrow in the step D indicates the movement of the mold 500. Accordingly, the arrow pointing downward shows a step of pressing a film-type mold onto a substrate, and the arrow pointing upward shows a step of separating the mold from the substrate), the step E of removing a mask in the portion (concave portion in the diagram showing the step D) corresponding to the negative pattern of the magnetic recording pattern (i.e., a step of removing both a resin film and a mask in those cases where a resin film still remains in the concave portion in the step D), the step F of partially subjecting to ion milling, from the side surface of the resin film 400 to the surface layer portion of the magnetic layer 200 (the reference numeral 700 indicates a part of the magnetic layer partially subjected to ion milling, and the reference symbol d indicates the depth of magnetic layer to which ion milling has been conducted), the step G of reforming magnetic properties of the magnetic layer by exposing to a reactive plasma or reactive ion 700 the part of the magnetic layer subjected to ion milling (the reference numeral 800 indicates a part of the magnetic layer in which magnetic properties have been reformed), the step H of removing the resin film 400 and the mask layer 300, a step of exposing the magnetic layer to an inert gas and the step I of covering the surface of the magnetic layer with a protective film 900. Note that although the above method is a preferable method that includes the step F of conducting ion milling, the method can be carried out without this step. In such a case, the exposed surface of the magnetic layer where the mask has been removed will be exposed to the reactive plasma or the reactive ions.

The mask layer 300 formed on top of the magnetic layer 200 in the step B in the method for manufacturing a magnetic recording medium according to the present invention is preferably formed using a material containing at least one selected from the group consisting of Ta, W, Ta nitrides, W nitrides, Si, SiO₂, Ta₂O₅, Re, Mo, Ti, V, Nb, Sn, Ga, Ge, As and Ni. By using such a material, the shielding properties of the mask layer 300 with respect to milling ion 600 can be improved and properties for forming the magnetic recording pattern using the mask layer 300 can also be improved. Furthermore, since the above-mentioned substances are easily dry-etched using reactive gas, in the step H depicted in FIG. 10, an amount of the residue and thus contamination on the surface of the magnetic recording medium can be reduced.

In the method for manufacturing a magnetic recording medium according to the present invention, among these substances, it is preferable to use As, Ge, Sn or Ga as the mask layer 300, more preferably Ni, Ti, V or Nb, and most preferably Mo, Ta or W. In general, the thickness of the mask layer 300 is preferably within the range from 1 nm to 20 nm.

In the present invention, as shown in the step C, a resin film is applied onto the magnetic layer 200 via the mask layer 300. As a resin film, those exhibiting favorable properties in terms of pattern transfer by a film-type mold can be used, and preferable examples thereof include an ultraviolet curing resin, such as a novolac-based resin, acrylic ester resins and alicyclic epoxy resins.

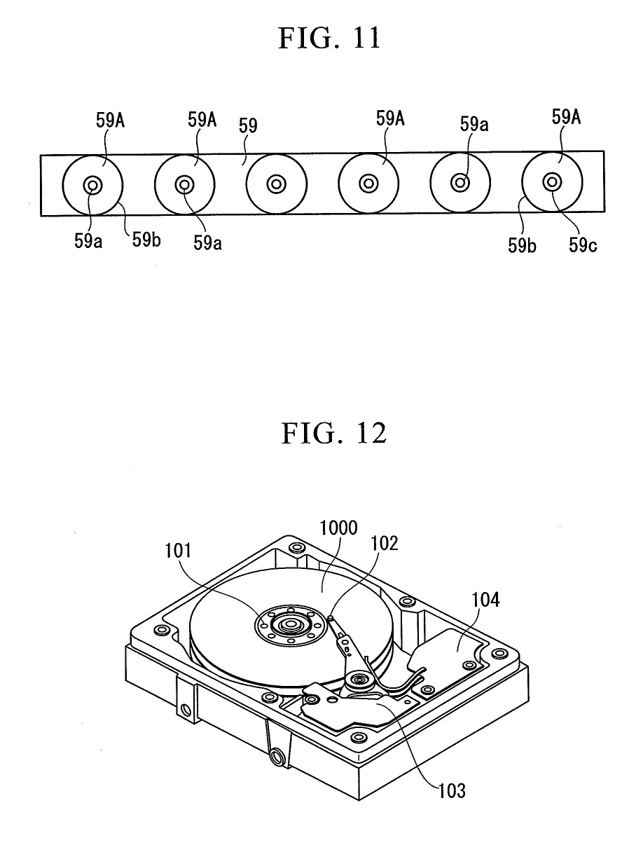

In the present invention, as shown in the step D, a film-type mold on which an uneven pattern has been formed is pressed against a resin film, thereby transferring the uneven pattern of the mold to the resin film, and the mold is then separated from the substrate. Here, for example, a pressure at which the film-type mold is pressed against the resin film can be set to 60 MPa or less. This pressure can be derived from the formula: ((compressive force)/(mold area)), in other words, can be determined by dividing the weight detected by a pressing machine with the mold area. In addition, the film-type mold can be made into any shapes, and can be made, for example, into a disc shape in which both the outer peripheral portion and the inner peripheral portion are punched. However, in the present invention, as mentioned earlier, it is preferable to use a long, film-type mold in which identical patterns are provided in succession as shown in FIG. 11, in view of the productivity of magnetic recording medium.

Further, as shown in FIG. 11, magnetic recording media can be manufactured with high productivity by providing an opening 59a to the long film, positioning the opening by making this opening 59a to coincide with the opening of the substrate, pressing the mold against the substrate using a radiation-transmitting jig, and irradiating radiation for curing the resin film from the jig side. In addition, in the film shown in FIG. 11, since molds having an identical pattern are provided in succession, it becomes possible to carry out each of the steps in succession, and also both surfaces of the substrate of magnetic recording media can easily be processed at the same time.

In the method for manufacturing a magnetic recording medium according to the present invention, following the transfer of a negative pattern of the magnetic recording pattern to the resin film 400 as shown in the steps C and D depicted in FIG. 10, it is preferable to make the thickness of a concave portion of the resin film 400 within the range from 0 to 10 nm. By making the thickness of a concave portion of the resin film 400 within the above-mentioned range, in the step of etching the mask layer 300 as shown in the step E depicted in FIG. 10, the occurrence of sag at the edge portion of the mask layer 300 can be suppressed, the shielding properties of the mask layer 300 with respect to milling ion 600 can be improved, and properties for forming the magnetic recording pattern using the mask layer 300 can also be improved. In general, the thickness of the resin film is within the range from about 10 nm to about 100 nm.

In the present invention, as a material to be used for the resin film 400 in the steps C and D depicted in FIG. 10, although it is preferable to use a radiation-curable material, either the irradiation of radiation to the resin film may be conducted during the step for transferring a pattern to the resin film 400 using a mold 500, or the irradiation to the resin film 400 may be carried out after the pattern transferring step. By employing such a manufacturing method, it becomes possible to transfer the shape of the mold 500 to the resin film 400 with high accuracy. Accordingly, in the step of etching the mask layer 300 as shown in the step E depicted in FIG. 10, the occurrence of sag at the edge portion of the mask layer 300 can be suppressed, the shielding properties of the mask layer with respect to injected ions can be improved, and properties for forming the magnetic recording pattern using the mask layer can also be improved. It should be noted that the term “radiation” used in the present invention is a concept that includes a wide range of electromagnetic waves, such as heat ray, visible light, ultraviolet ray, X-ray and gamma ray. In addition, radiation-curable materials refer to, for example, a thermosetting resin when the radiation is heat ray and an ultraviolet curing resin when the radiation is ultraviolet ray.

In the method of manufacturing a magnetic recording medium according to the present invention, especially in the step of transferring a pattern to the resin film 400 using the mold 500, it becomes possible to transfer the shape of the mold to the resin film with high accuracy by pressing the mold against the resin film while the resin film is exhibiting a high level of fluidity, and irradiating radiation onto the resin film to cure the resin film while the mold is still being pressed against the resin film, followed by the separation of the mold from the resin film. As a method for irradiating radiation to the resin film while pressing the mold against the resin film, in addition to the method of irradiating radiation from the side opposite to that of the mold as mentioned earlier, a method of irradiating radiation from the substrate side, a method of irradiating radiation from the side surface of the mold, or a method of irradiating radiation through thermal conduction from the mold material or substrate using highly conductive radiation with respect to a solid material, such as heat ray can also be used.

By employing the method of the present invention as described above, by impairing the magnetic properties in the region between magnetic tracks (i.e., the region separating the respective magnetic layers), for example, by reducing the level of coercive force and residual magnetization to the utmost limit, it becomes possible to provide a magnetic recording medium having a high surface recording density which is capable of preventing the bleeding during magnetic recording.

In the present invention, as shown in the step F, it is preferable to remove a portion of the surface of the magnetic layer by ion milling or the like. When removing a portion of the surface of the magnetic layer and then reforming the magnetic properties of the magnetic layer by exposing the surface to reactive plasma or reactive ions as in the case of the present invention, the contrast of the magnetic recording pattern becomes sharper and the S/N ratio of the magnetic recording medium is also improved, as compared to the case where a portion of the magnetic layer has not been removed. The reason for this is presumed as follows. Since the surface portion of the magnetic layer is removed, the surface becomes clean and is activated and thus reactivity with the reactive plasma or the reactive ion is increased. Further, since defects, such as voids, are introduced in the surface portion of the magnetic layer, the reactive ion easily penetrates into the magnetic layer through the defects.

In the present invention, the depth d up to which a portion of the surface of the magnetic layer is removed by ion milling or the like is preferably within the range from 0.1 nm to 15 nm, more preferably within the range from 1 to 10 nm. In those cases where the removal depth by the ion milling is less than 0.1 nm, the effect of removal of the magnetic layer mentioned above will not be achieved. On the other hand, in those cases where the removal depth is greater than 15 nm, surface smoothness of the magnetic recording medium deteriorates and thus the floating properties of the magnetic head deteriorates when producing the magnetic recording and reproducing apparatus.

The present invention is characterized by forming a region that magnetically separates, for example, the magnetic recording track and the servo signal pattern portion, by reforming the magnetic properties (i.e., by impairing the magnetic properties) of the magnetic layer by exposing the magnetic layer on which films have already been formed to the reactive plasma or the reactive ion.

As shown in the step G depicted in FIG. 10, the magnetic recording pattern which is magnetically separated as described in the present invention refers to a state where a magnetic layer 200 is separated by regions 800 which have been non-magnetized, when viewing the magnetic recording medium from the surface side. In other words, in those cases where the magnetic layer 200 is separated when viewed from the surface side, the object of the present invention can be achieved even if the magnetic layer 200 is not separated at the bottom thereof, and thus these cases fall within the concept of magnetic recording pattern, which is magnetically separated, adopted in the present invention. In addition, the term “magnetic recording pattern” used in the present invention includes those in the so-called patterned media in which a magnetic recording pattern is arranged with certain regularity for each one bit, those in the media in which a magnetic recording pattern is arranged in tracks, and other patterns such as servo signal patterns or the like.

Of the various examples described above, it is preferable to apply the present invention to a so-called discrete type magnetic recording medium, in which magnetically separated magnetic recording patterns are the magnetic recording track and servo signal patterns, from the viewpoint of simplicity in manufacture. In the present invention, reforming of the magnetic layer for the sake of forming the magnetic recording pattern refers to causing a partial change in, for example, coercive force and residual magnetization of the magnetic layer in order to pattern the magnetic layer, and the change refers to decrease in coercive force, residual magnetization, or the like.

Furthermore, the present invention can also be achieved by making the magnetic layer, to which films have already been formed, amorphous by exposing a part of the magnetic layer that magnetically separates the magnetic recording track and the servo signal pattern portion to the reactive plasma or the reactive ion. Reforming of the magnetic properties of the magnetic layer in the present invention also includes alteration of the crystal structure of the magnetic layer. In the present invention, making the magnetic layer amorphous refers to making the atomic arrangement of the magnetic layer into an irregular atomic arrangement with no long distance order, and more specifically, refers to making the atomic arrangement of the magnetic layer into a state where microcrystalline grains having diameters less than 2 nm are randomly arranged. When confirming the state of the atomic arrangement by an analytical process, a state is obtained through X-ray diffraction or electron diffraction in which no peaks representing crystal faces are recognized and only a halo is recognized.

Examples of the reactive plasma used in the present invention include inductively coupled plasma (ICP) and reactive ion plasma (RIB). Further, examples of the reactive ion used in the present invention include the reactive ion present in the inductively coupled plasma and reactive ion plasma mentioned above.

The inductively coupled plasma refers to high-temperature plasma obtained by applying a high voltage to gas, thereby forming plasma, and further generating the Joule's heat by an eddy current inside the plasma by a varying magnetic field of high frequency. The inductively coupled plasma has high electron density and thus enables the reforming of magnetic properties at high efficiency in a magnetic film with a large area compared with a conventional case where discrete track media are manufactured using an ion beam. The reactive ion plasma is the highly reactive plasma in which a reactive gas, such as O₂, SF₆, CHF₃, CF₄ and CCl₄, is added to the plasma. By using such plasma as the reactive plasma in the present invention, it is possible to achieve the reforming of the magnetic properties of the magnetic film with higher efficiency.

In the present invention, it is preferable that the reactive plasma or the reactive ion include a halogen ion, and it is particularly desirable that the halogen ion be a halogen ion formed by introducing at least one halogenated gas selected from the group consisting of CF₄, SF₆, CHF₃, CCl₄ and KBr into the reactive plasma, in view of enhancing the reactivity between the magnetic layer and the plasma and also in view of sharpening the pattern to be formed. The reason for this observation is not yet clear in detail. However, it is thought that the halogen atom in the reactive plasma etches the foreign substances formed on the surface of the magnetic layer, as a result of which the surface of the magnetic layer is cleaned, thereby enhancing the reactivity of the magnetic layer. In addition, it is also possible that the cleaned surface of the magnetic layer reacts with halogen atoms at high efficiency.

Although the magnetic layer is reformed by exposing the magnetic layer to which films have been formed to the reactive plasma in the present invention, the reforming is preferably performed by reaction of the magnetic metal which constitutes the magnetic layer with atoms or ions in the reactive plasma. The term “reaction” used herein includes alteration of the crystal structure of the magnetic metal, alteration of the composition of the magnetic metal, oxidation of the magnetic metal, nitridation of the magnetic metal and silication of the magnetic metal, among others, due to penetration of atoms or the like in the reactive plasma into the magnetic metal.

Thereafter, in the present invention, as depicted in the step H, the resist 400 and the mask 300 are removed. For this removal step, a technique such as dry etching, reactive ion etching, ion milling and wet etching can be employed.

Then, in the present invention, as depicted in the step I, the magnetic layer activated by the steps F, G and H is exposed to an inert gas, thereby stabilizing the magnetic layer. The reason why the magnetic layer is stabilized and the occurrence of migration of the magnetic particles or the like is suppressed even under a high temperature, high humidity environment by the provision of such a step is not evident. However, it is thought that either migration of the magnetic particles is suppressed due to the penetration of inert elements into the surface of the magnetic layer, or migration of the magnetic particles or the like is suppressed because the surface of the magnetic layer which has been active is removed by the exposure to an inert gas.

As an inert gas used in the present invention, it is preferable to use at least one gas selected from the group consisting of Ar, He and Xe. This is because these elements are stable and are also highly effective in suppressing the migration of magnetic particles. For the exposure to an inert gas in the present invention, it is preferable to employ any one of the devices or methods selected from the group consisting of ion gun, ICP and RIE. Among these, it is particularly desirable to employ ICP or RIE in view of achieving high dose. As for the descriptions on the ICP and RIE used herein, the same applies as mentioned earlier.

In the present invention, as depicted in the step I, after forming the protective film 900, it is preferable to include a step for manufacturing a magnetic recording medium by applying a lubricant thereto. Although the protective film 900 is generally formed by forming a thin film of Diamond Like Carbon by, for example, a P-CVD method, the present invention is not limited thereto. The protective film may be a carbonaceous layer composed of carbon (C), hydrogenated carbon (H×C), carbon nitride (CN), amorphous carbon, silicon carbide (SiC) or the like, or other materials that are usually employed as a protective layer material, such as SiO₂, Zr₂O₃ and TiN. Further, the protective film may be constituted of two or more layers.

The thickness of the protective film 900 needs to be less than 10 nm. This is because when the thickness of the protective film is more than 10 nm, the distance between the head and the magnetic layer becomes too great, which may cause the input and output signal intensity to become insufficient. It is preferable to form a lubricating layer on top of the protective film. Examples of the lubricant used for the lubricating layer include a fluorine-based lubricant, a hydrocarbon-based lubricant and a mixture thereof, and the lubricating layer is usually formed with a thickness of 1 to 4 nm.

Next, a configuration of a magnetic recording and reproducing apparatus of the present invention is shown in FIG. 12. The magnetic recording and reproducing apparatus of the present invention is an apparatus having the aforementioned magnetic recording medium 1000 of the present invention, and a medium driving unit 101 that drives the medium in the recording direction, a magnetic head 102 constituted of a recording section and a reproducing section, a head driving unit 103 which moves the magnetic head 102 relative to the magnetic recording medium 1000, and a recording/reproducing signal processing system 104 that combines recording/reproduction signal processing devices for carrying out the signal input to the magnetic head 102 and the reproduction of output signals from the magnetic head 102. A combination of these components enables the configuration of a magnetic recording and reproducing apparatus with high recording density. In the conventional cases, the width of the reproducing head has been made narrower than that of the recording head in order to eliminate the influence of magnetic transition regions at track edge portions. However, in the present invention, the reproducing head width and the recording head width are made substantially the same because the magnetic track of the magnetic recording medium has been processed in a magnetically discontinuous manner. As a result, sufficient reproduction output and high SNR can be achieved.

Further, by constituting the reproducing section of the aforementioned magnetic head with a GMR head or a TMR head, sufficient signal strength can be obtained even under high recording density, and thus a magnetic recording and reproducing apparatus with high recording density can be achieved. Furthermore, when the magnetic head is raised at a flying height of 0.005 μm to 0.020 μm, which is lower than that in the conventional cases, the output is increased and the device SNR is also enhanced. As a result, a magnetic recording and reproducing apparatus that has a large capacity and is highly reliable can be provided. In addition, when a signal processing circuit of a maximum likelihood decoding system is combined, the recording density can further be improved. For example, a sufficiently high SNR can be achieved even when the recording and reproducing are performed with the track density of not less than 100K tracks per inch, linear recording density of 1000K bits per inch and the recording density of not less than 100 G bits per 1 square inch.

### EXAMPLES

### <Preparation of Laminated Film>

Laminated films A to F were prepared by applying a UV curable resin indicated in Table 1 onto a hard film indicated in Table 1, followed by drying under adequate conditions. The constitutions of the films A to H are shown in Table 1.

### <Preparation of Film-Type Mold>

A mother stamper was prepared by forming an uneven concentric pattern on the surface of a doughnut shaped disc having a thickness of 0.3 mm, an inner diameter of 16 mm and an outer diameter of 63.5 mm and made by Ni electroforming, the pattern in which the height difference between a convex portion and a concave portion was 80 nm, the width of the convex portion was 120 nm and the width of the concave portion was 80 nm, and the mother stamper was set by making the patterned surface to face upward. Each of the laminated films A to H prepared in the above-mentioned manner was cut into a long shape with a width of 70 mm and was set by making the surface to which an epoxy acrylate solution has been applied to face downward.

After fastening the die, the mother stamper was pressed against the laminated film at a pressure of 30 MPa for 10 seconds, and UV light was then irradiated for 20 seconds by adjusting the illumination intensity of an irradiation device (equipped with an LED lamp having a wavelength of 365 nm) at 30 mW/cm² while applying the pressure. The irradiation of UV light was then stopped, and a hole having a diameter of 12 mm was made at the center of the pattern using an inner peripheral cutter blade. Thereafter, the upper die set was raised, thereby releasing the die. This operation was repeated for 1,000 times in the long direction with an interval of 80 mm, thereby preparing a film-type mold in which identical patterns were provided in succession in the long direction. Note that two pieces of film-type molds were each prepared by using the laminated films A to H.

<Preparation of Substrate for Magnetic Recording Medium Attached with Resist Film>

A vacuum chamber with a glass substrate for a magnetic recording medium being placed therein was evacuated to a pressure of 1.0×10⁻⁵ Pa or less in advance. The glass substrate used herein was made of a crystallized glass including Li₂Si₂O₅, Al₂O₃—K₂O, Al₂O₃—K₂O, MgO—P₂O₅, and Sb₂O₃—ZnO as constituting components, and had an outer diameter of 65 mm, an inner diameter of 20 mm and an average surface roughness (Ra) of 2 angstrom.

Thin films of a 65Fe-30Co-5B alloy to be served as a soft magnetic layer, Ru to be served as an intermediate layer, and a 74Co-6Cr-18Pt-2SiO₂ alloy (these numerals indicate the molar ratio) to be served as a magnetic layer were laminated in this order on the glass substrate using a DC sputtering process. The thickness of the FeCoB soft magnetic layer was 60 nm, the thickness of the Ru intermediate layer was 10 nm and the thickness of the magnetic layer was 15 nm. A mask layer was then formed thereon by a sputtering process. The mask layer was constituted of Ta and the thickness thereof was 60 nm. A resist was applied by a spin coating method on both surfaces of the magnetic recording medium. PAK-01 (manufactured by Toyo Gosei Co., Ltd.) which was an ultraviolet curing resin was used as a resist. In addition, the resin was diluted and adjusted with a solvent so that the resulting film thickness was 100 nm.

### <Imprinting on the Resist Film Placed on the Substrate for a Magnetic Recording Medium Using a Film-Type Mold>

The substrate for a magnetic recording medium which was prepared in the aforementioned example was sandwiched by the film-type molds prepared in the aforementioned example from both sides using jigs made of quartz so that the mold surface was opposed to the resin film side of the substrate for a magnetic recording medium. Note that a cylindrical rod having a diameter of 20 mm was provided perpendicularly in one of the quartz jigs for aligning the positions of the substrate for a magnetic recording medium and the film-type mold. After pressing for 10 seconds with a pressing force of 0.6 MPa using 2 of these quartz jigs, UV light was irradiated from the quartz jig side at an illumination intensity of 30 mW/cm² using an LED lamp having a wavelength of 365 nm while the pressing force remained unchanged. Thereafter, the film-type mold is separated from the substrate for a magnetic recording medium, and the film-type mold was recovered by a film-winding machine. The thickness of the resist layer on the substrate surface was 80 nm and the thickness of the concave portion of the resist layer was about 5 nm. In addition, the angle of the concave portion of the resist layer was about 90 degrees with respect to the substrate surface. The imprinting on the resist layer was carried out on 1,000 pieces of substrates for each films using the films A to H.

### <Formation and Property Evaluation of Magnetic Recording Pattern>

Then, a part of the resist layer corresponding to the concave portion and a Ta layer therebelow were removed by dry etching. In terms of the conditions for dry etching, the resist was etched using O₂ gas of 40 sccm, a pressure of 0.3 Pa, a high-frequency plasma power of 300 W, a DC bias of 30 W and an etching time of 10 seconds, whereas the Ta layer was etched using CF₄ gas of 50 sccm, a pressure of 0.6 Pa, a high-frequency plasma power of 500 W, a DC bias of 60 W and an etching time of 30 seconds.

Then, the surface of a part of the magnetic layer which was not covered by the mask layer was removed by ion milling. Ar ions were used for the ion milling process. The conditions for the ion milling process were a high-frequency discharge power of 800 W, an accelerating voltage of 500 V, a pressure of 0.014 Pa, an Ar flow rate of 5 sccm, a processing time of 40 seconds and a current density of 0.4 mA/cm². The surface on which ion milling was conducted was exposed to reactive plasma and the magnetic properties of the exposed portion in the magnetic layer were reformed. An inductively coupled plasma device NE550 available from ULVAC, Inc. was used in the reactive plasma treatment of the magnetic layer. In terms of the gas and conditions used for generating plasma, CF₄ was used (90 cc/min) with a supplied power for plasma generation of 200 W and a pressure inside the chamber of 0.5 Pa, and the magnetic layer was processed for 300 seconds.

Then, the resist layer and the mask layer were removed by dry etching. The conditions for dry etching were the use of an SF₆ gas at 100 sccm, a pressure of 2.0 Pa, a high-frequency plasma power of 400 W and a processing time of 300 seconds. Thereafter, inert gas plasma was irradiated onto the surface of the magnetic layer. The conditions for the irradiation of inert gas plasma were: the use of an inert gas (5 sccm), a pressure of 0.014 Pa, an accelerating voltage of 300 V, a current density of 0.4 mA/cm² and a processing time of 10 seconds 0.4 nm of a carbon (i.e., DLC: diamond like carbon) protective film was deposited on the surface thereof, and a lubricant was then applied thereon to manufacture a magnetic recording medium.

With respect to a total of 8,000 pieces of the magnetic recording media manufactured in the above-mentioned example (1,000 pieces each, manufactured using the films A to H), the defective rate for the formed patterns was examined. The defective rate for the formed patterns was calculated by defining those in which 3% or more of the tracks formed on the surface of a magnetic recording medium exhibited defective patterns as the defective products. As a result, it was found that the defective rate for the magnetic recording medium manufactured by using the film A was 3.6%, 2.9% for the magnetic recording medium manufactured by using the film B, 4.0% for the magnetic recording medium manufactured by using the film C, 1.9% for the magnetic recording medium manufactured by using the film D, 2.7% for the magnetic recording medium manufactured by using the film E, 3.2% for the magnetic recording medium manufactured by using the film F, 3.7% for the magnetic recording medium manufactured by using the film G, and 1.2% for the magnetic recording medium manufactured by using the film H. Accordingly, magnetic recording media were manufactured with high productivity in all cases using any of these films.

TABLE 1

| | Hard Film | | | | | | | |
|---|---|---|---|---|---|---|---|---|
| | | Tensile | | | | UV curable resin | | |
| | | elastic | Tensile | UV | | | | Film |
| Laminated | | modulus | elongation | transmittance ⁷⁾ | Thickness | | Drying | Thickness |
| Film | Product Name | (GPa) | (%) | (%) | (μm) | Content | Conditions | (μm) |
| A | Cosmoshine A-4100 ¹⁾ | | 120 | >30% | 100 | NIL-A-1 ⁸⁾ | No drying | 2 |
| B | Cosmoshine A-4100 ¹⁾ | | | | | Acrylic | 80° C. for 60 | 10 |
| | | | | | | additive a ⁹⁾ | minutes | |
| C | Cosmoshine A-4100 ¹⁾ | | | | | Acrylic | No drying | 10 |
| | | | | | | additive b ¹⁰⁾ | | |
| D | Teonex Q65FA ²⁾ | | 110 | >30% | 100 | Acrylic | 80° C. for 60 | 10 |
| | | | | | | additive a ⁹⁾ | minutes | |
| E | ZF-14 ³⁾ | | 40 | >30% | 188 | Acrylic | 80° C. for 60 | 10 |
| | | | | | | additive a ⁹⁾ | minutes | |
| F | Panlite sheet | 2.5 | 50 | >30% | 300 | NIL-A-1 | No drying | 2 |
| | PC2151 ⁴⁾ | | | | | | | |
| G | Oburan X-88B ⁵⁾ | 2.1 | 60 | >30% | 50 | Acrylic | 80° C. for 60 | 10 |
| | | | | | | additive a ⁹⁾ | minutes | |
| H | Thermosetting | 2.6 | 3 | >30% | 50 | Acrylic | 80° C. for 60 | 10 |
| | urethane | | | | | additive a ⁹⁾ | minutes | |
| | resin film ⁶⁾ | | | | | | | |

¹⁾ Polyethylene terephthalate film manufactured by Toyobo Co., Ltd.
²⁾ Polyethylene naphthalate film manufactured by Teijin DuPont Films Japan Limited.
³⁾ Zeonorsheet manufactured by Optes Inc.
⁴⁾ Aromatic polycarbonate sheet manufactured by Teijin Chemicals Ltd.
⁵⁾ Methylpentene copolymer film manufactured by Mitsui Chemicals, Inc.
⁶⁾ An independent film prepared by adding and adequately mixing 10 g of UCE-5 (manufactured by Meisei Chemical Workds, Ltd.), 0.95 g of Celloxide 2021P (manufactured by Daicel Chemical Industries, Ltd) and 0.05 g of Curezol 1B 2PZ (manufactured by Shikoku Chemicals Corporation), cast molding the resulting mixture on a polyethylene terephthalate film, and hot forming the resultant at 80° C. for 1 hour and the n at 120° C. for 3 hours, followed by separation of the polyethylene terephthalate film.
⁷⁾ Results with respect to ultraviolet light having a wavelength within a range from 300 nm to 400 nm.
⁸⁾ NIF-A-1 manufactured by Asahi Glass Co., Ltd.
⁹⁾ A mixture prepared by adding and adequately mixing 100 g of a phenol novolac type epoxy acrylate solution Kayarad PNA-170H (product name, manufactured by Nippon Kayaku Co., Ltd.) and 2.0 g of a radical photopolymerization initiator Irgacure 184 (product name, manufactured by Ciba Specialty Chemicals Inc.).
¹⁰⁾ A mixture prepared by adding and adequately mixing 30 g of a polyfunctional acrylate Kayarad DPHA (product name, manufactured by Nippon Kayaku Co., Ltd.), 30 g of (product name, N-vinyl formamide manufactured by Arakawa Chemical Industries, Ltd.), 90 g of a bifuncational acrylate Kayarad R-167 (product name, manufactured by Nippon Kayaku Co., Ltd.) and 4.5 g of Irgacure 127 (product name, manufactured by Ciba Specialty Chemicals Inc.).

### INDUSTRIAL APPLICABILITY

According to the present invention, a magnetic recording medium exhibiting excellent electromagnetic conversion characteristics and having high recording density can be provided with high productivity, and thus the present invention is highly industrially applicable.

1. A method of manufacturing a magnetic recording medium having magnetic recording patterns which are magnetically separated, the method comprising, in the following order:
a step of forming a magnetic layer on a substrate which has an opening in the center;
a step of applying a resin film onto the magnetic layer;
a step of pressing against the substrate a film-type mold on which an uneven pattern has been formed;
a step of transferring the uneven pattern of the mold onto the resin film;
a step of separating the mold from the substrate; and
a step of forming a magnetic recording pattern on the magnetic layer using the uneven pattern which has been transferred.

2. The method of manufacturing a magnetic recording medium according to claim 1,
wherein the film-type mold has an opening, and the mold is pressed against the substrate by making this opening to coincide with the opening of the substrate.

3. A method of manufacturing a magnetic recording medium,
wherein identical patterns are provided in succession on the film-type mold, thereby conducting in succession the steps of claim 1 on a plurality of substrates.

4. The method of manufacturing a magnetic recording medium according to claim 1,
wherein the resin film applied onto the magnetic layer is a radiation-curable resin, and radiation for curing the resin is irradiated from the back surface of the mold when transferring the uneven pattern of the mold onto the resin film.

5. The method of manufacturing a magnetic recording medium according to claim 1,
wherein the step of applying a resin film onto the magnetic layer, the step of pressing against the substrate a film-type mold on which an uneven pattern has been formed and the step of transferring the uneven pattern of the mold onto the resin film are carried out simultaneously on both surfaces of the substrate.

6. A magnetic recording and reproducing apparatus comprising a combination of:
a magnetic recording medium manufactured by the method of manufacturing a magnetic recording medium of claim 1;
a driving unit that drives the magnetic recording medium in the recording direction;
a magnetic head constituted of a recording section and a reproducing section;
a head driving unit that relatively moves the magnetic head with respect to the magnetic recording medium; and
a recording/reproduction signal processing device that inputs signals to the magnetic head and reproduces output signals from the magnetic head.
